(19) United States
(12) Patent Application Publication
(10) Pub. No.: US 2025/0296171 A1
(43) Pub. Date: Sep. 25, 2025

(54) SPOT WELDING TIP FOR SHORT FLANGE OF CAR BODY PANEL AND SPOT WELDING MACHINE INCLUDING THE SAME

(71) Applicants: Hyundai Motor Company, Seoul (KR); Kia Corporation, Seoul (KR); Dong-eui University Industry-Academic Cooperation Foundation, Busan (KR)

(72) Inventors: Hun Cho, Hwaseong-Si (KR); Yeong Do Park, Busan (KR)

(21) Appl. No.: 18/926,026

(22) Filed: Oct. 24, 2024

(30) Foreign Application Priority Data
Mar. 19, 2024 (KR) 10-2024-0037645

(51) Int. Cl. B23K 11/11

(52) U.S. Cl. CPC B23K 11/115; B23K 3/025

(57) ABSTRACT

A spot welding tip for a short flange of a car body panel may include a tip mounting portion having a cylindrical structure and forming a closed upper surface, and a truncated cone-shaped tip head portion formed in a vertical direction from a center of the upper surface of the tip mounting portion, wherein a fore end diameter of the tip head portion is formed to be smaller than a diameter of the tip mounting portion. A spot welding machine may include and/or operate with the spot welding tip

### CROSS-REFERENCE TO RELATED APPLICATION

This application claims priority to and the benefit of Korean Patent Application No. 10-2024-0037645 filed in the Korean Intellectual Property Office on Mar. 19, 2024, the entire contents of which are incorporated herein by reference.

### TECHNICAL FIELD

The present disclosure relates to a spot welding tip for a short flange of a car body panel and a spot welding machine including the same, and more specifically, to a spot welding tip for a short flange for joining an aluminum panel applied for reducing a weight of a car body and a spot welding machine including the same.

### BACKGROUND

Automobiles are produced via production processes of press, car body, painting, and design. Among these processes, the most important process that determines the degree and quality of the Body In White (BIW) of the car body is an assembly process of car body parts using resistance welding techniques.

The automobile market is rapidly changing from internal combustion engine (ICE) vehicles to electric vehicles (EV). Electric vehicles preferably have lighter car bodies in order to improve a travelable distance and energy efficiency. Accordingly, an increasing number of manufacturers are applying aluminum panels and short flanges not only to the BIW of the car body but also to moving parts such as bonnets, doors, and tailgates.

For example, for the tailgate, the design is being changed to a short flange where a flange length of the aluminum panel is reduced (for example, 20 mm→12 mm) in order to reduce the weight of the car body and improve rear opening visibility. However, the spot welding where a cap tip diameter (for example, 20 mm) of a spot welding machine of the related art is applied has problems of causing interference with a curved portion of the short flange and geometric constraints, which deteriorates a welding quality.

Therefore, in vehicle factories, securing a resistance welding technique adapted to aluminum panels and short flanges applied to car bodies is considered a key of production technology.

Note that in the case of the short flange welding technique of the related art, spot welding, projection welding, and laser welding using dome type electrodes can be used.

For example, FIG. 10 shows problems with short flange welding using dome type electrodes of the related art.

Referring to FIG. 10, in the case of short flange welding using dome type electrodes of the related art, two dome type welding tips 1 and 2 with a fore end diameter of 6 mm are used to cope with width and length limitations of the short flanges 3 and 4. In this case, the dome type welding tips 1 and 2 can perform spot welding using electric current while bringing hemispherical tip face surfaces with curvature radii of R and R1, respectively, into contact with upper and lower portions of a short flange and applying pressure.

However, the short flange welding using dome type electrodes of the related art has a problem in that separation and spatter phenomena occur at an end portion of the short flange depending on the welding time. Also, or alternatively, the dome type welding tips 1 and 2 with a fore end diameter of 6 mm have a small contact area, so the cooling performance is limited and aluminum fusion frequently occurs due to excessive heat generation on the tip face surfaces due to high current density. For this reason, there is a problem in that the number of weldable spots is reduced and frequent tip dressing is required.

In the case of short flange welding using projection welding, the number of weld points by protrusions can be increased. However, there is a disadvantage of increasing the man-hours because it is necessary to form separate protrusions on the short flange for projection welding, and there is a problem of causing poor robot gun teaching for tracking the weld points.

In the case of short flange welding using laser welding, there is a disadvantage in that the welding quality varies depending on an overlapping state of the panels at a welded portion. Therefore, in order to secure laser welding quality, a jig and additional equipment to minimize a gap are required, which increases the initial investment cost.

The matters described in the background art section are to enhance understanding of the background of the disclosure, and may include matters that have not been known to one skilled in the art to which the present technology belongs.

### SUMMARY

The following summary presents a simplified summary of certain features. The summary is not an extensive overview and is not intended to identify key or critical elements.

Systems, apparatuses, and methods are described for a spot wielding tip and spot welding machine comprising the same. A spot welding tip may comprise: a tip mounting portion having a cylindrical structure with a closed circular surface; and a tip head portion having a truncated cone shape and extending, from a center of the closed circular surface, away from the tip mounting portion. A fore end diameter of a fore end portion of the tip head portion may be smaller than a diameter of the tip mounting portion.

A spot welding gun may comprise: a plurality of spot welding tips, wherein at least one spot welding tip, of the plurality of spot welding tips, comprises: a tip mounting portion having a cylindrical structure with a closed circular surface; and a tip head portion having a truncated cone shape extending, from a center of the closed circular surface, away from the tip mounting portion, wherein a fore end diameter of a fore end portion of the tip head portion is smaller than a diameter of the tip mounting portion. The spot welding gun may further comprise a body configured to position the plurality of spot welding tips to be in contact with a first panel and a second panel to be welded to the first panel; a welding pressurization unit configured to pressurize, via an actuator, the first panel and the second panel during spot welding; a welding transformer unit configured to supply a welding current during the spot welding; and a cooling unit configured to cool, via a cooling fluid, the plurality of spot welding tips.

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 shows a configuration of a spot welding gun to which a spot welding tip for a short flange of a car body panel according to an example of the present disclosure is applied.

FIG. 2 schematically shows a structure of the spot welding tip for a short flange of a car body panel according to an example of the present disclosure.

FIG. 3 is a cross-sectional view showing a welded state of a short flange using the spot welding tip according to an example of the present disclosure.

FIGS. 4 and 5 show results of welding quality evaluation of the spot welding tip for a short flange according to an example of the present disclosure.

FIG. 6 shows results of measuring a temperature change at an interface between the spot welding tip and the panel during welding according to an example of the present disclosure.

FIG. 7 shows life test results of the spot welding tip for a short flange according to an example of the present disclosure.

FIG. 8 shows a method of welding aluminum panels of different thicknesses using the same type of spot welding tips according to a first alternative example of the present disclosure.

FIG. 9 shows a method of welding aluminum panels of different thicknesses using different types of welding tips according to a second alternative example of the present disclosure.

FIG. 10 shows problems with short flange welding using dome type electrodes of the related art.

### DETAILED DESCRIPTION

In the following detailed description, only certain examples of the present disclosure have been shown and described, simply by way of illustration.

The terminology used herein is for the purpose of describing specific examples only and is not intended to be limiting the present disclosure. As used herein, the singular forms are intended to include the plural forms as well, unless the context clearly indicates otherwise. It will be further understood that the terms “comprises” and/or “comprising”, if used in the present specification, specify the presence of stated features, integers, steps, operations, constitutional elements, and/or components, but do not preclude the presence or addition of one or more other features, integers, steps, operations, constitutional elements, components, and/or groups thereof. As used herein, the term “and/or” includes any one or all combinations of the associated listed items.

Throughout the specification, terms such as first, second, A, B, (a), (b), etc. may be used to describe various constitutional elements, but the constitutional elements should not be limited by the terms. The terms are only used to distinguish the constitutional elements from other constitutional elements, and the nature, sequence, or order of the corresponding constitutional element is not limited by the term.

Throughout the specification, if it is mentioned that a certain constitutional element is “connected” or “coupled” to another constitutional element, it should be understood that the certain constitutional element may be directly connected or coupled to the other constitutional element or another intervening constitutional element may be present therebetween. Conversely, if it is mentioned that a certain constitutional element is ‘directly connected” or “directly coupled” to another constitutional element, it should be understood that there is no intervening constitutional element present therebetween.

The terms throughout the specification are merely used to describe specific examples of the present disclosure but are not intended to limit the present disclosure. The singular forms “a”, “an” and “the” are intended to include plural forms as well, unless the context clearly indicates otherwise.

Additionally, it is understood that one or more of the methods or aspects thereof below may be executed by at least one or more control units. The term “controller” may refer to a hardware device that includes a memory and a processor. The memory is configured to store program instructions and the processor is specially programmed to execute the program instructions so as to perform one or more processes described in more detail below. The controller, as described herein, may control operations of units, modules, components, devices, or the like. It is also understood that the methods below may be executed by a device that includes a control unit along with one or more other components, as will be appreciated by one skilled in the art.

Now, a spot welding tip for a short flange of a car body panel according to an example of the present disclosure and a spot welding machine including the same will be described in detail with reference to the drawings.

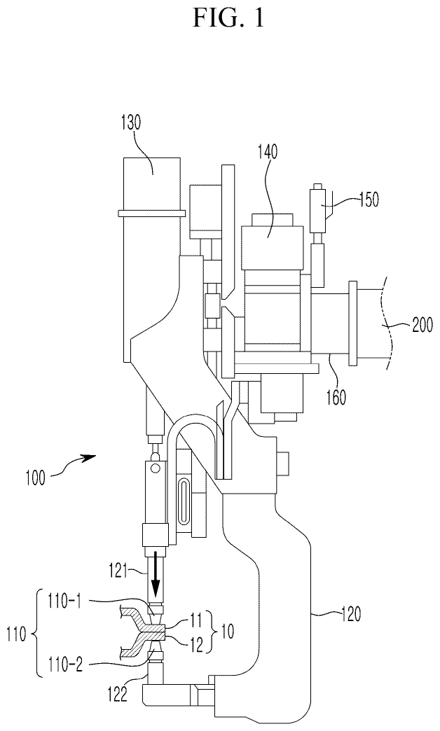

FIG. 1 shows a configuration of a spot welding gun to which a spot welding tip for a short flange of a car body panel according to an example of the present disclosure is applied.

Referring to FIG. 1, a spot welding gun 100 for a short flange according to an example of the present disclosure is applied to a welding robot 200 that performs spot welding in order to assemble a car body panel 10 in a car body part assembling process.

The car body panel 10 may include an upper panel 11 (e.g., a first panel) and a lower panel 12 (e.g., a second panel) butted each other. Hereinafter, throughout the specification, “upper” and “lower” refer to the positions/directions shown in FIG. 1 (e.g., positions/directions of each of the panels 11 and 12 and each of the welding tips 110-1 and 110-2). The directions of “upper” and “lower” are not limited to a particular orientation/position in space (e.g., relative to a direction of gravity).

At least one of the upper panel 11 and the lower panel 12 may be made of aluminum or aluminum alloy material (e.g., for reducing the weight of a car body). In particular, the car body panel 10 in the example of the present disclosure refers to a short flange portion of an aluminum panel applied to a moving part such as a bonnet, a door, and a tailgate of a vehicle.

Therefore, the spot welding gun 100 for a short flange of a car body panel according to an example of the present disclosure may include a spot welding tip 110 manufactured in a structure corresponding to a short flange formed on at least one of the upper panel 11 or the lower panel 12, a body unit 120 where a plurality of spot welding tips 110-1 and 110-2 to be in contact with the upper panel 11 and the lower panel 12 are mounted vertically, a welding pressurization unit 130 that pressurizes a car body panel 10 using an actuator during spot welding, a welding transformer unit 140 that supplies welding current during spot welding, and a cooling unit 150 that cools the plurality of spot welding tips 110-1 and 110-2 through a cooling fluid during spot welding. Here, the spot welding gun 100 may further include a robot mounting bracket 160 for mounting to a welding robot 200.

The spot welding tip 110 and the spot welding gun 100 may be implemented corresponding to a short flange portion of the car body panel 10 made of aluminum material for reducing a weight of a car body.

The spot welding tip 110 may include a first welding tip 110-1 and a second welding tip 110-2 provided corresponding to the upper panel 11 and the lower panel 12.

The body unit 120 may include a first shank 121 to which the first welding tip 110-1 is vertically mounted from an upper part, and a second shank 122 to which the second welding tip 110-2 is vertically mounted from a lower part. Therefore, during spot welding, the body unit 120 can cause the first welding tip 110-1 to come into contact with a short flange of the upper panel 11 vertically and the second welding tip 110-2 to come into contact with a short flange of the lower panel 12 vertically.

The spot welding gun 100 can be implemented as a C-Type and/or X-Type depending on a frame shape of the body unit 120. The spot welding gun 100 can be implemented as a servo gun and/or air gun type depending on an actuator (for example, a motor/air compressor) of the welding pressurization unit 130.

The welding transformer unit 140 may convert welding current supplied from a welding controller 400 to high current suitable for spot welding and/or supply the same in a state in which the first welding tip 110-1 and the second welding tip 110-2 are engaged to and pressed against the object to be welded 10.

The welding robot 200 may mount the spot welding gun 100 to a tip of an arm of a multi-joint structure and/or move to a designated welding point location to perform a continuous welding operation.

For example, the welding robot 200 may sequentially move to designated welding points. The welding robot 200 may first fix the second welding tip 110-2 in a state in which the second welding tip is in contact with the short flange portion of the lower panel 12. The spot welding gun 100 can pressurize the short flange portion of the upper panel 11 by lowering the first welding tip 110-1 through the welding pressurization unit 130 in the fixed state.

Accordingly, the spot welding gun 100 may engage and/or pressurize the short flange portion of the car body panel 10 using the first welding tip 110-1 and the second welding tip 110-2.

In the description of the background of the disclosure, it was presented that the short flange welding using dome type electrodes of the related art has problems in that separation and/or spatter phenomena occur at an end portion of the short flange, depending on the welding time. Also, or alternatively, it was presented that the limited cooling performance of the dome type welding tips 1 and 2 with a fore end diameter of 6 mm and the frequent fusion due to excessive heat generation on the tip face surfaces cause frequent tip dressing.

Accordingly, an example of the present disclosure provides a spot welding tip 110 of an improved shape in order to solve the problem of welding tip deterioration by reducing a temperature at an interface (electrode/panel) during spot welding, e.g., of an aluminum car body panel applied for reducing a weight of a car body, and to eliminate/reduce interference with the short flange.

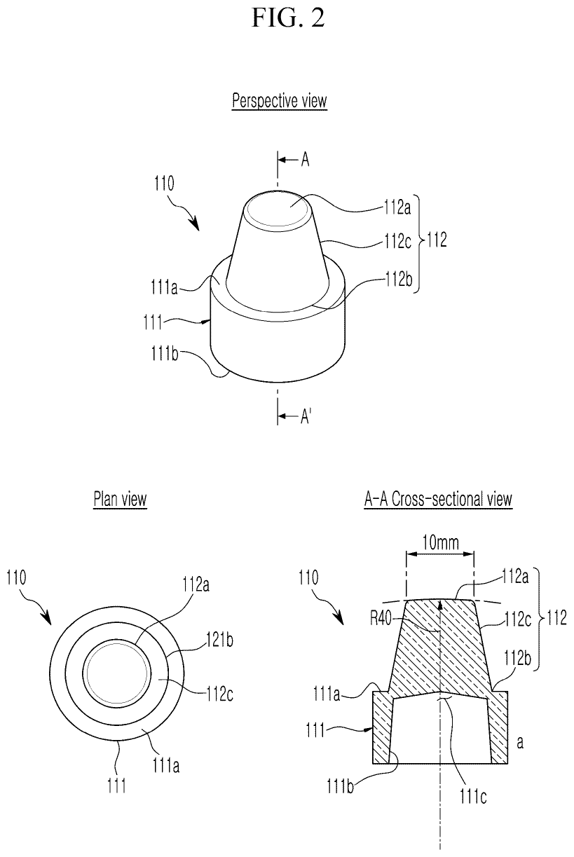

FIG. 2 schematically shows a structure of the spot welding tip for a short flange of a car body panel according to an example of the present disclosure.

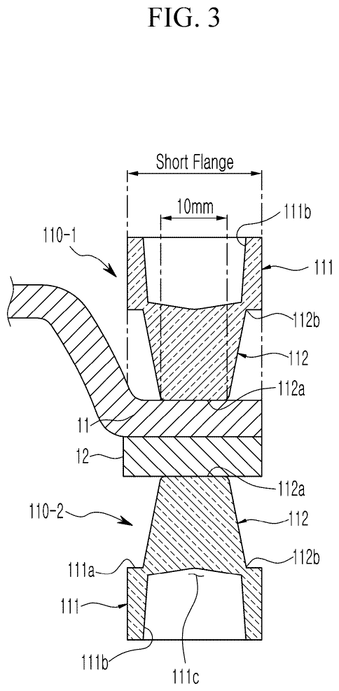

FIG. 3 is a cross-sectional view showing a welded state of a short flange using the spot welding tip according to an example of the present disclosure.

Referring to FIGS. 2 and 3, the spot welding tip 110 corresponding to a short flange of an aluminum panel forming a car body according to an example of the present disclosure may include a tip mounting portion 111 having a cylindrical structure and forming a closed upper surface 111a (a closed circular surface and/or a closed base surface), and a truncated cone-shaped tip head portion 112 formed in a vertical direction from a center of the upper surface 111a of the tip mounting portion 111, and a fore end diameter of the tip head portion 112 may be formed to be smaller than a diameter (ø) of the tip mounting portion 111. Herein, “fore” refers to a direction away from the tip mounting portion/towards a welding tip of the tip head portion, and “rear” refers to an opposite to the “fore” direction.

A fore end portion of the tip head portion 112 may have a partial spherical shape, and/or may have a partial arc shape (e.g., in a cross-section parallel to a fore-rear direction). Accordingly, the fore end portion of the tip head portion 112 may have a set radius of curvature.

Also, or alternatively, a rear end diameter 112b of the tip head portion 112 may be larger than the fore end diameter 112a and smaller than the diameter of the tip mounting portion 111. Accordingly, the spot welding tip 110 may form a step between the upper surface 111a of the tip mounting portion 111 and the rear end diameter of the tip head portion 112.

The radius of curvature of the fore end portion of the tip head portion 112 and the fore end diameter of the tip head portion 112 may have a set ratio. For example, the ratio of the radius of curvature of the fore end portion of the tip head portion 112 and the fore end diameter of the tip head portion 112 may be 4:1. To this end, the radius of curvature of the fore end portion of the tip head portion 112 may be R40 (mm), and the fore end diameter of the tip head portion 112 may be 10 (mm).

The tip head portion 112 of the spot welding tip 110 is manufactured with a radius of curvature of R40 and a fore end diameter 112a of 10 mm to promote efficient cooling of a surface portion of the welding tip and ensure a favorable contact area between an electrode and a car body panel surface. Hereinafter, in the example of the present disclosure, the spot welding tip 110 manufactured as above may be called rondure and its dimensions may be expressed in a format such as Rd10f-R40.

An outer peripheral surface 112c corresponding to a body of the tip head portion 112 may have a shape maintaining a constant inclination angle from the fore end diameter 112a to the rear end diameter 112b reaching a shank assembly region 111c formed in an assembly groove 111b of the tip mounting portion 111. For example, the outer peripheral surface 112c of the tip head portion 112 may have a shape (structure) maintaining an inclination angle of 12° and having a diameter gradually decreasing from the rear end diameter 112b to the fore end diameter 112a.

According to the shape of the tip head portion 112, unlike the dome type welding tips 1 and 2 of the related art, a rapid change in current density can be reduced and excessive heat generation on a surface can be prevented. Therefore, contamination of the tip head portion 112 due to aluminum fusion can be reduced.

Also, or alternatively, the tip head portion 112 may have an advantage of improving concentration of the current density by the fore end diameter 112a of 10 mm, enabling a larger nugget diameter to be secured even at a lower current than the dome type welding tips 1 and 2 of the related art.

The tip mounting portion 111 may have the same diameter as the upper surface 111a.

The tip mounting portion 111 forms an assembly groove 111b opening a lower portion and a shank region 111c of a certain space formed inside the assembly groove 111b and close to the rear end diameter 112b of the tip head portion 112. That is, the tip mounting portion 111 forms a structure that can be vertically assembled to the shank 121 or 122 of the welding gun 100 through the shank region 111c and cooled at the same time. Therefore, deterioration of the spot welding tip 110 can be prevented through sufficient cooling during short flange welding.

The first welding tip 110-1 and the second welding tip 110-2 of the spot welding tip 110 according to the description may be formed as a same shape.

Note that results of welding quality evaluation of the spot welding tip 110 for a short flange according to an example of the present disclosure will be described. Hereinafter, in the drawings, the spot welding tip 110 according to an example of the present disclosure may be indicated by rondure or applied dimensions (Rd10f-R40). Additionally, a dome type welding tip of the related art is indicated by Dome8f (the fore end diameter of 8 mm is applied).

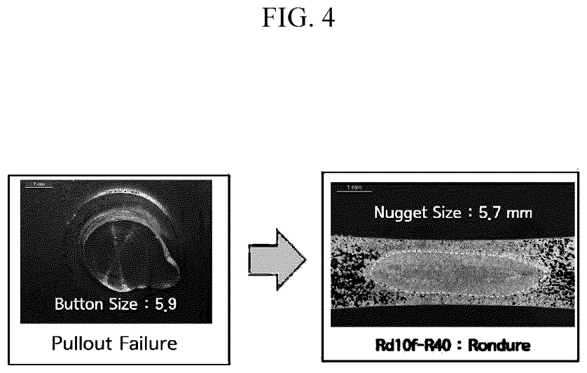

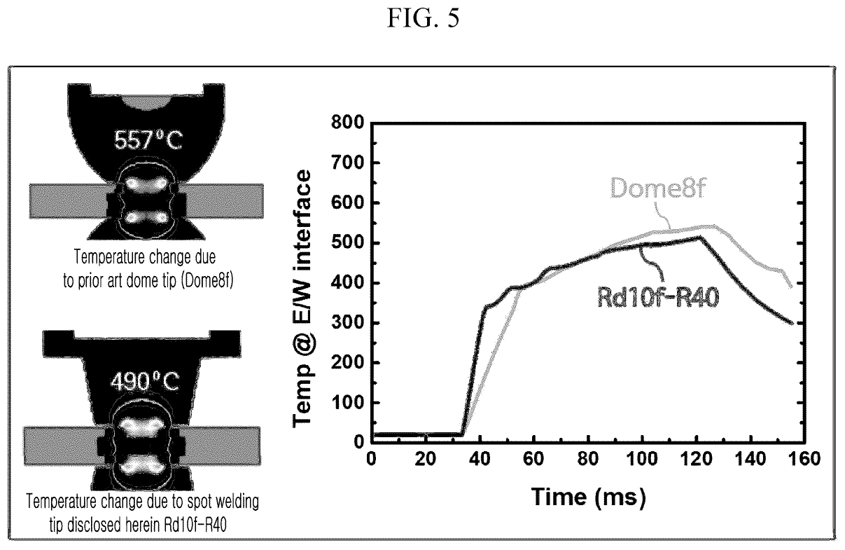

FIGS. 4 and 5 show results of welding quality evaluation of the spot welding tip for a short flange according to an example of the present disclosure.

First, FIG. 4 shows a result that the welding quality of the upper and lower panels 11 and 12 made of the same material (A6014 1t/A6014 1t) was evaluated using the spot welding tip 110 of Rd10f-R40 according to an example of the present disclosure. At this time, it can be seen that the spot welding tip 110 is effective in securing a nugget diameter of about 5.7 mm and a button diameter of 5.9 mm even at a low current of 28 kA.

Also, or alternatively, FIG. 5 shows results of temperature simulation during welding using the spot welding tip (Rd10f-R40) of the present disclosure and the dome type welding tip (Dome8f) of the related art. At this time, as a result of checking the temperatures of the surfaces of the two welding tips if securing similar nugget diameters, it can be seen that the surface temperature (490° C.) of the spot welding tip (Rd10f-R40) according to the present disclosure was maintained low compared to the surface temperature (557° C.) of the dome type welding tip (Dome8f) of the related art.

The spot welding tip (Rd10f-R40) according to an example of the present disclosure can be applied to both tip mounting portions with diameters of 16 mm and 20 mm, and unlike the dome type welding tip (Dome8f) of the related art, does not have a large change in diameter, which can minimize a surface current density and heat generation.

Also, or alternatively, if the spot welding tip (Rd10f-R40) according to an example of the present disclosure is applied to the welding gun 100, it is possible to ensure welding quality for a short flange of a car body panel and reduce a tip dressing cycle since the progression of electrode deterioration is slow.

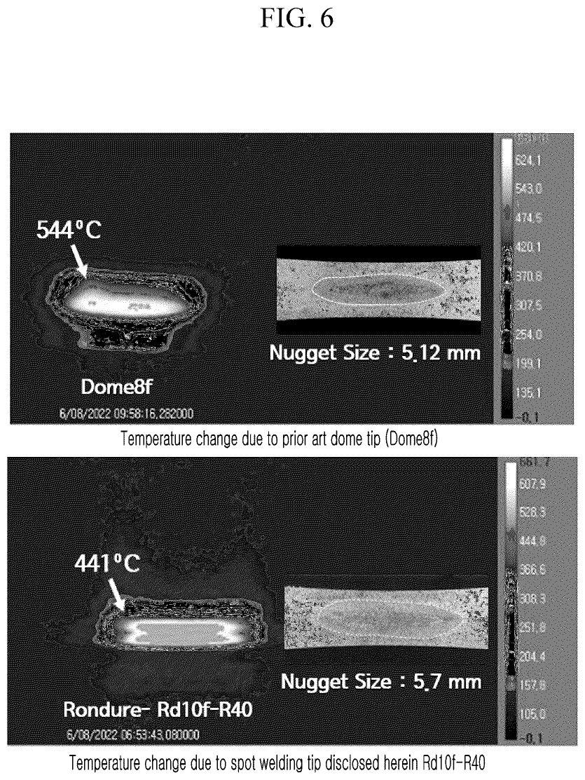

FIG. 6 shows results of measuring a temperature change at an interface between the spot welding tip and the panel during welding according to an example of the present disclosure.

FIG. 6 shows results of measuring a temperature change at the interface using an infrared (IR) camera in order to further verify the temperature reduction effect at the interface between the spot welding tip (Rd10f-R40) and the panel confirmed through the results of welding quality evaluation described above.

Comparison between the spot welding tip of the present disclosure (Rd10f-R40) and the dome type welding tip (Dome8f) of the related art was performed on nugget diameters of similar sizes. At this time, as a result of temperature comparison using an IR camera, it was confirmed that the interface temperature of the spot welding tip (Rd10f-R40) of the present disclosure was 441° C. and the interface temperature of the dome type welding tip (Dome8f) of the related art was 544° C., resulting in a temperature reduction effect of about 100° C.

As such, the highest temperature value obtained from the actual measurement results using the IR camera is consistent with the previous experiment and simulation results. Therefore, the effect that the spot welding tip according to an example of the present disclosure reduces the surface contact temperature at the interface can be further confirmed.

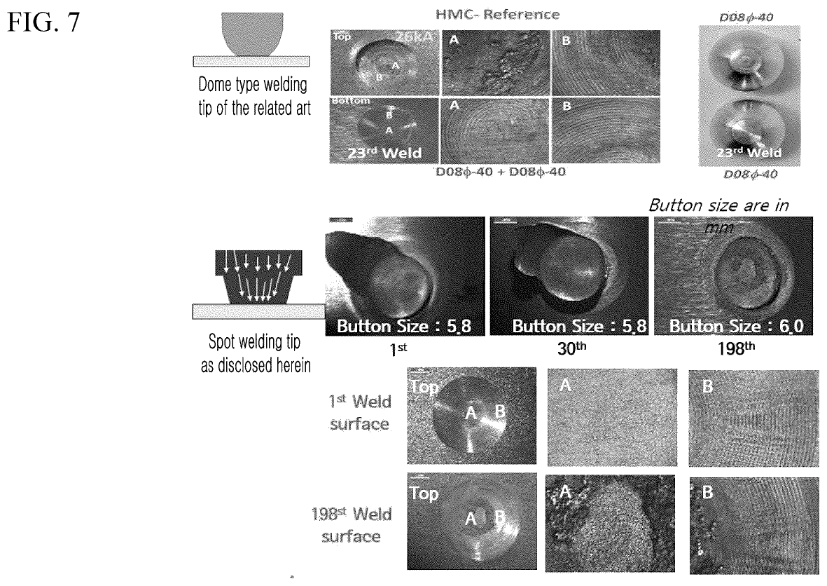

FIG. 7 shows life test results of the spot welding tip for a short flange according to an example of the present disclosure.

FIG. 7 shows results of life test of a welding tip performed in order to verify the accuracy and reliability of the previous simulation and experiment results.

The dome type welding tip (Dome8f) of the related art has a disadvantage in that the nugget diameter at a first spot starts at about 5.9 mm, and a panel heat fusion (sticking) phenomenon occurs at a 23rd spot due to electrode deterioration, so the welding tip life does not reach even a 30th spot.

In contrast, in the case of the spot welding tip (Rd10f-R40) according to an example of the present disclosure, the button diameter was maintained at 5.8 to 6.0 mm for all of the initial first spot, 30th spot, and 198th spot, confirming that there was no deterioration in welding quality.

In particular, the spot welding tip (Rd10f-R40) of the present disclosure may have the effect of extending the dressing cycle by suppressing the heat fusion phenomenon due to surface deterioration during continuous welding up to 198th spot.

This effect can be achieved by the optimized shape corresponding to the short flange where the temperature generated at the interface between the spot welding tip (Rd10f-R40) according to the example of the present disclosure and the panel is maintained low, so the molten nugget does not reach the surface (i.e., the pick-up of aluminum of the panel to the spot welding tip is suppressed).

Although the examples of the present disclosure have been described above, the present disclosure is not limited to the above-described examples and various other modifications can be made.

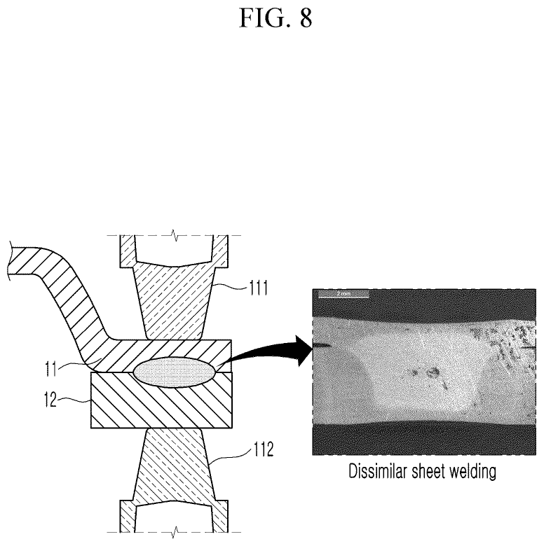

For example, FIG. 8 shows a method of welding aluminum panels of different thicknesses using the same type of spot welding tips according to a first alternative example of the present disclosure.

Referring to FIG. 8, in the above-described example of the present disclosure, the description focuses on welding the short flange portions of the aluminum panels 11 and 12 of the same thickness butted each other at the upper and lower parts using the spot welding tip 110.

However, the example of the present disclosure is not limited thereto, and the aluminum panels 11 and 12 of different thicknesses applied at the upper and lower parts can be spot welded using the same type of spot welding tips 110-1 and 110-2 in the spot welding machine 100. In this case, it can be confirmed that the heat generation at the interface between the spot welding tip and the panel is maintained at a low level, and thus the same effect as in the above-described example can be achieved.

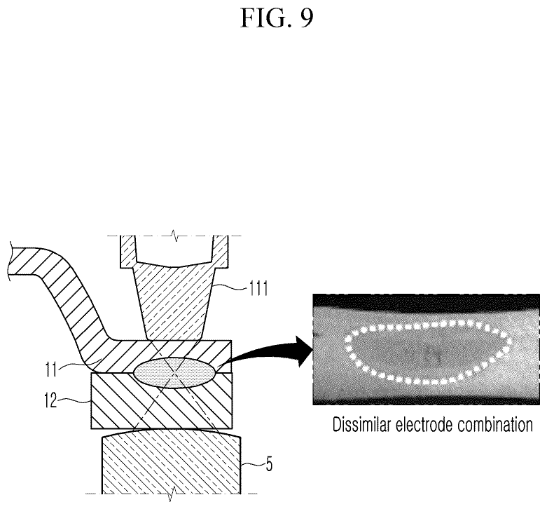

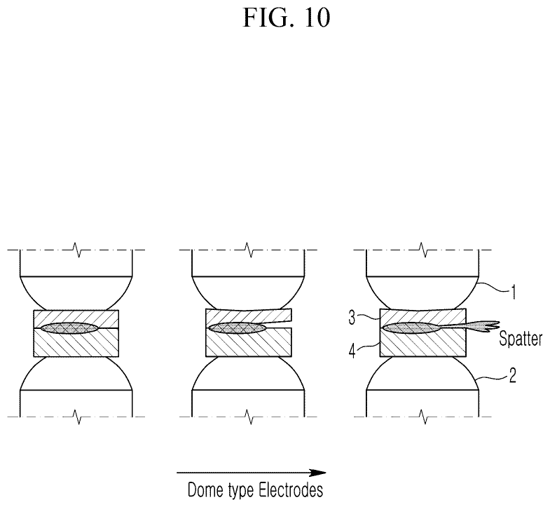

Also, or alternatively, FIG. 9 shows a method of welding aluminum panels of different thicknesses using different types of welding tips according to a second alternative example of the present disclosure.

Referring to FIG. 9, the aluminum panels 11 and 12 of different thicknesses applied at the upper and lower parts can be spot welded using different types of welding tips in the spot welding machine 100.

For example, the welding gun 100 according to the second alternative example of the present disclosure can perform spot welding by applying the spot welding tip 110 according to the example of the present disclosure to the thin upper panel 11 to which the short flange is applied, in order to cope with the limitations of the short flange, and applying a radius type of welding tip (flat tip) 5 to the lower panel 12, which is thicker than the upper panel 11.

In this case, the heat balance during spot welding moves to the interface between the upper panel 11 and the lower panel 12, which may have the effect of increasing the nugget diameter at the interface.

Also, or alternatively, if the spot welding tip 110 according to an example of the present disclosure is applied to one of the aluminum panels depending on the thicknesses of the aluminum panels, it is possible to secure excellent nugget diameter and welding quality at a welded portion even at a lower welding current compared to the related art.

An example of the present disclosure attempts to provide a spot welding tip for a short flange of a car body panel of an optimized shape in order to solve the problem of welding tip deterioration by reducing a temperature at an interface during spot welding of an aluminum panel applied for reducing a weight of a car body and to eliminate interference with the short flange, and a spot welding machine including the spot welding tip.

According to an aspect of the present disclosure, a spot welding tip for a short flange of a car body panel may include a tip mounting portion having a cylindrical structure and forming a closed upper surface; and a truncated cone-shaped tip head portion formed in a vertical direction from a center of the upper surface of the tip mounting portion, wherein a fore end diameter of the tip head portion may be smaller than a diameter of the tip mounting portion.

Also, or alternatively, the tip head portion is manufactured with a radius of curvature of R40 and a fore end diameter of 10 mm in consideration of a contact area for cooling a surface portion of the welding tip.

Also, or alternatively, the tip head portion may have a rear end diameter formed to be larger than the fore end diameter and smaller than the diameter of the tip mounting portion, and a step may be formed between the upper surface of the tip mounting portion and the rear end diameter of the tip head portion.

Also, or alternatively, the tip head portion may maintain a certain inclination angle on an outer peripheral surface from the fore end diameter to the rear end diameter reaching a shank region formed in an assembly groove of the tip mounting portion.

Also, or alternatively, the spot welding tip may have such a shape that the outer peripheral surface of the tip head portion maintains an inclination angle of 12° and a diameter of the outer peripheral surface gradually decreases from the rear end diameter to the fore end diameter.

Also, or alternatively, the tip mounting portion may include an assembly groove opening a lower portion; and a shank region of a certain space formed inside the assembly groove and close to a lower end of the tip head portion.

Also, or alternatively, the tip mounting portion may have a structure that can be vertically assembled to a shank of a welding gun through the shank region and cooled at the same time.

According to an aspect of the present disclosure, a spot welding gun for a short flange of a car body panel may include a spot welding tip manufactured in a structure corresponding to a short flange formed on at least one of an upper panel and a lower panel; a body unit where a plurality of spot welding tips to be in contact with the upper panel and the lower panel are mounted vertically; a welding pressurization unit configured to pressurize the car body panel using an actuator during spot welding; a welding transformer unit configured to supply welding current during the spot welding; and a cooling unit configured to cool the plurality of spot welding tips through a cooling fluid during the spot welding, wherein the spot welding tip may include a tip mounting portion having a cylindrical structure and forming a closed upper surface; and a truncated cone-shaped tip head portion formed in a vertical direction from a center of the upper surface of the tip mounting portion, wherein a fore end diameter of the tip head portion may be smaller than a diameter of the tip mounting portion.

According to an example of the present disclosure, during spot welding using the spot welding tip having a truncated cone-shaped tip head manufactured with a radius of curvature of R40 and a fore end diameter of 10 mm, it is possible to prevent deterioration in welding quality due to interference with the short flange and geometric constraints.

Also, or alternatively, the rounded spot welding tip (Rd10f-R40) according to an example of the present disclosure can secure a nugget diameter and button diameter sufficient for welding quality even at low current, and unlike the dome type welding tip (Dome8f) of the related art, does not have a large change in diameter, which can minimize a surface current density and heat generation.

Also, or alternatively, the welding gun to which the spot welding tip (Rd10f-R40) according to an example of the present disclosure is applied can ensure welding quality for a short flange of a car body panel, and reduce a tip dressing cycle by suppressing the progression of electrode deterioration.

The examples of the present disclosure are not implemented only through the devices and/or methods described above, and may also be implemented through a program for realizing functions corresponding to the configuration of the examples of the present disclosure, a recording medium on which the program is recorded, and the like. Such implementation can be easily realized by one skilled in the art to which the present disclosure belongs, based on the example described above.

Although examples of the present disclosure have been described in detail herein, the scope of the present disclosure is not limited thereto. Various modifications and/or improvements made by one skilled in the art by using the basic concepts of the present disclosure defined in the following claims also fall within in the scope of the present disclosure.

What is claimed is:

1. A spot welding tip comprising:
a tip mounting portion having a cylindrical structure with a closed circular surface; and
a tip head portion having a truncated cone shape and extending, from a center of the closed circular surface, away from the tip mounting portion,
wherein a fore end diameter of a fore end portion of the tip head portion is smaller than a diameter of the tip mounting portion.

2. The spot welding tip of claim 1, wherein:
the fore end portion of the tip head portion has a radius of curvature in a direction that the tip head portion extends away from the tip mounting portion.

3. The spot welding tip of claim 2, wherein:
a ratio of the radius of curvature of the fore end portion of the tip head portion to the fore end diameter of the tip head portion is 4:1.

4. The spot welding tip of claim 2, wherein:
the radius of curvature of the fore end portion of the tip head portion is 40 mm, and the fore end diameter of the tip head portion is 10 mm.

5. The spot welding tip of claim 1, wherein:
the tip head portion has a rear end portion having a rear end diameter larger than the fore end diameter and smaller than the diameter of the tip mounting portion, such that a step is formed by the closed circular surface of the tip mounting portion and the rear end diameter of the tip head portion.

6. The spot welding tip of claim 5, wherein:
the tip head portion has an inclination angle of an outer peripheral surface between the fore end portion and the rear end portion, which is adjacent to a shank region in an assembly groove formed in the tip mounting portion.

7. The spot welding tip of claim 6, wherein:
the inclination angle is 12° and a diameter of the outer peripheral surface gradually decreases from the rear end diameter to the fore end diameter.

8. The spot welding tip of claim 1, wherein:
the tip mounting portion forms an assembly groove opening away from the closed circular surface and the tip head portion; and
the assembly groove comprises a shank region towards the tip head portion.

9. The spot welding tip of claim 8, wherein:
the tip mounting portion is configured to accept a shank of a welding gun via the shank region while being cooled.

10. A spot welding gun comprising:
a plurality of spot welding tips, wherein at least one spot welding tip, of the plurality of spot welding tips, comprises:
a tip mounting portion having a cylindrical structure with a closed circular surface; and
a tip head portion having a truncated cone shape extending, from a center of the closed circular surface, away from the tip mounting portion, wherein a fore end diameter of a fore end portion of the tip head portion is smaller than a diameter of the tip mounting portion;
a body configured to position the plurality of spot welding tips to be in contact with a first panel and a second panel to be welded to the first panel;
a welding pressurization unit configured to pressurize, via an actuator, the first panel and the second panel during spot welding;
a welding transformer unit configured to supply a welding current during the spot welding; and
a cooling unit configured to cool, via a cooling fluid, the plurality of spot welding tips.

11. The spot welding gun of claim 10, wherein the at least one spot welding tip comprises a first spot welding tip and a second spot welding tip, and wherein the body is configured to position:
the first spot welding tip to be in contact with the first panel at a first contact point, and
the second spot welding tip to be in contact with the second panel at a second contact point opposite the first contact point.

12. The spot welding tip of claim 11, wherein:
the fore end portion of the tip head portion has a radius of curvature in a direction that the tip head portion extends away from the tip mounting portion.

13. The spot welding tip of claim 12, wherein:
a ratio of the radius of curvature of the fore end portion of the tip head portion to the fore end diameter of the tip head portion is 4:1.

14. The spot welding tip of claim 12, wherein:
the radius of curvature of the fore end portion of the tip head portion is 40 mm, and the fore end diameter of the tip head portion is 10 mm.

15. The spot welding tip of claim 11, wherein:
the tip head portion has a rear end portion having a rear end diameter larger than the fore end diameter and smaller than the diameter of the tip mounting portion, such that a step is formed by the closed circular surface of the tip mounting portion and the rear end diameter of the tip head portion.

16. The spot welding tip of claim 15, wherein:
the tip head portion has an inclination angle of an outer peripheral surface between the fore end portion and the rear end portion, which is adjacent to a shank region in an assembly groove formed in the tip mounting portion.

17. The spot welding tip of claim 16, wherein:
the inclination angle is 12° and a diameter of the outer peripheral surface gradually decreases from the rear end diameter to the fore end diameter.

18. The spot welding tip of claim 11, wherein:
the tip mounting portion forms an assembly groove opening away from the closed circular surface and the tip head portion; and
the assembly groove comprises a shank region towards the tip head portion.

19. The spot welding tip of claim 18, wherein:
the tip mounting portion is configured to accept a shank of a welding gun via the shank region while being cooled.
